(19) United States
(12) Patent Application Publication
(10) Pub. No.: US 2002/0069749 A1
(43) Pub. Date: Jun. 13, 2002

(54) Basic sustainer components

(76) Inventors: Alan Anderson Hoover, Indianapolis, IN (US); Gary Thomas Osborne, Indianapolis, IN (US)

Correspondence Address: Alan A. Hoover, 3937 Cranbrook Drive, Indianapolis, IN, 46240, US

(21) Appl. No.: 09/819,047

(22) Filed: Dec. 12, 2000

(51) Int. Cl. G10H 3/26

(52) U.S. Cl. 84/738

(57) ABSTRACT

A sustainer for a musical instrument has at least one vibratory element arranged in a longitudinal direction. The sustainer provides a drive signal to a sustainer driver. The driver has a plurality of flux emitters disposed in an end-to-end relation perpendicular to the vibratory element. The driver emits a magnetic field to apply drive forces to the vibratory element in response to the drive signal. At least two of the flux emitters are magnetized by oppositely polarized permanent magnets. The flux emitters are arranged to narrow a magnetic gap between at least two of the flux emitters having oppositely polarized permanent magnets. The flux emitters are arranged such that they overlap each other in a direction perpendicular to the longitudinal direction in order to improve magnetic drive of the vibratory element when the vibratory element is located near the magnetic gap.

### PRIOR ART

### FIELD OF THE INVENTION

The present invention relates to a magnetic vibration sustainer for musical instruments having vibratory elements such as strings, reeds, or the like that produce the musical tones of the instrument and to improvement of the performance and control of the sustainer.

### BACKGROUND OF THE INVENTION

Basic Sustainer Components

A sustainer for electric stringed musical instruments comprises the following three main components:

(1) A pickup for sensing the vibrations of the vibrating elements of the musical instrument and producing an output electrical signal representative of the vibrations of the vibratory elements; (2) an amplifier which accepts the output signal from the pickup at the amplifier input and amplifies this pickup signal; (3) a driver which accepts the amplified pickup signal at the amplifier output and provides a pulsating drive force in response to the amplified pickup signal, where the pulsating drive force impinges upon the vibratory elements which causes the vibration of the vibratory elements to be sustained. This is known as “feedback sustain”.

The musical instrument on which sustainers are most commonly used is a stringed musical instrument such as an electric guitar. Such an instrument typically includes a plurality of strings and at least one pickup mounted to the instrument body and disposed in close proximity to the strings, which senses the vibration of the instrument strings and produces an electrical output signal in response to the vibrations of the strings. Often, the strings are made of magnetically permeable steel. The most commonly used pickup is the well-known magnetic pickup. Numerous brands and models of magnetic pickups are well known in the art and are available on the market, of both single-coil and humbucking construction. These are very popular with modern guitar players, because they make it possible to achieve a variety of instrument tones. Some electric guitars have other types of pickups, such as piezo-electric pickups or microphones to produce the pickup output signal in response to the string vibrations.

Sustainers for musical instruments tend to be of two different general types: (1) magnetic sustainers; (2) acoustic sustainers.

The difference between the two is primarily the method by which vibrational energy is transferred into the strings if the instrument. This involves the design of the driver. The driver for magnetic sustainers emits a pulsating magnetic field in response to the amplified pickup signal. This magnetic field impinges upon the vibrating elements or strings of the instrument, causing feedback sustain. The driver for acoustic sustainers is typically an electromagnetic transducer, which acoustically vibrates some part of the body of the instrument, or some component located on the instrument. This acoustic vibrational energy is then transferred to the strings through the body or other part of the instrument, causing feedback sustain to occur.

Magnetic Sustainer Characteristics

Magnetic sustainers are now commonly sold for use in electric guitars. A desirable characteristic for a magnetic sustainer is that it provide robust sustain of the instrument string vibrations. This general quality of robustness means that the sustainer will have at least the following specific qualities:

(1) The sustained string vibrations will quickly build up in amplitude if the strings are only lightly plucked or otherwise set into vibration.

(2) The sustained string vibrations will have sufficient amplitude to provide adequate loudness.

(3) The sustainer should force all of the instrument strings to have sustained vibration characteristics described in (1) and (2), not just some of them.

(4) The sustainer operation should not inhibit or impede any of a wide variety of playing styles.

In order to force quick vibration amplitude build-up of lightly plucked strings, a large sustainer amplifier gain is usually necessary. If the amplifier gain is not large, then many sustained notes will either be weak in amplitude or the string vibrations will completely die out. The amplifier gain will also affect the sustained vibration amplitude.

As amplifier gain is increased in order to increase robustness of the sustainer, an undesirable oscillatory condition sometimes occurs: Pulsating magnetic radiation from the driver is received by the instrument pickup. The pickup then produces an induced output voltage signal in response to this sensed pulsating magnetic radiation. The induced pickup output voltage is then amplified and applied to the driver input. A regenerating feedback loop is created. This oscillatory feedback condition occurs at the frequency of highest gain where the overall phase shift is zero degrees. The gain/phase condition is primarily determined by the self-resonant characteristics of the magnetic pickup. This uncontrolled oscillation is typically unrelated to the vibration frequency of the string that the musician is trying to sustain. It is very undesirable for such an uncontrolled oscillatory condition to occur. One important key to minimizing the tendency to oscillate at high gain settings is found to be in the magnetic driver design.

Driver Characteristics for Magnetic Sustainers

The inventors believe that there are at least four very important characteristics for magnetic sustainer driver transducers for electric guitars:

(1) The driver should have a size and shape that allows it to fit into standard size pickup cutouts in the bodies of popular electric guitars without having to modify the body of the instrument in order to fit the driver into the pickup cutout;

(2) The appearance of the driver should be similar to that of commercially successful electric guitar pickups, so that the change in the overall appearance of the instrument as a result of mounting the driver into an existing pickup cutout is minimal;

(3) The pulsating magnetic field that the driver produces in response to the amplified pickup signal should be confined to the strings immediately above the driver, so that a minimal amount of radiated field reaches the sustainer pickup. This third characteristic reduces the tendency for an uncontrolled oscillatory condition to occur, and allows the sustainer amplifier gain to be set to a high enough value that robust sustainer operation is possible;

(4) The driver should have the capability for operating as a pickup when the sustainer is turned off.

Prior art magnetic sustainers for electric guitar have possessed these sustainer and driver characteristics with varying degrees of success.

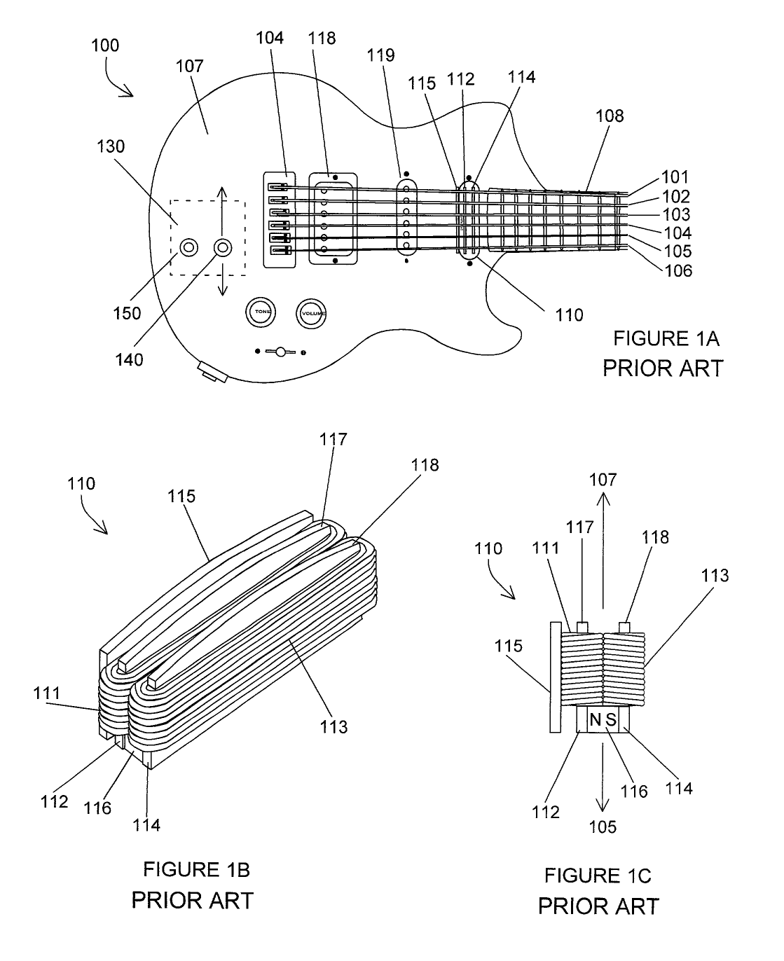

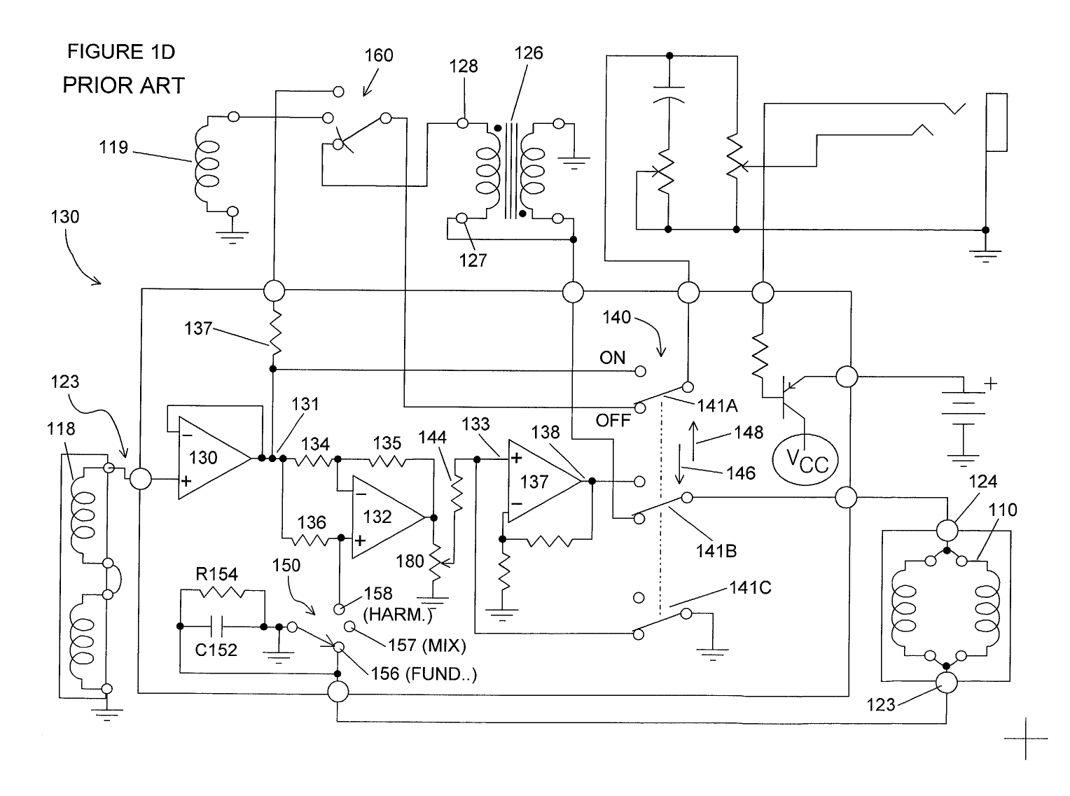

In our U.S. Pat. No. 4,941,388, the present inventors described a sustainer which was designed to have robust performance as defined above. The '388 driver minimizes magnetic radiation at the physical location of an instrument pickup. FIG. 1 shows a sustainer as described in the '388 patent, comprising circuit 130, driver 110, and bridge pickup 118. Driver 110 is shown in some detail in FIGS. 1B and 1C. This driver design enabled sufficient sustainer amplifier gain to be set so that sustainer performance was quite robust, without uncontrolled oscillation occurring. A commercial sustainer having a driver as described and claimed in '388 was sold and was commercially successful. Many are still being used at the present time.

FIG. 1a shows a plan view of the '388 driver 110 mounted into the body 107 of electric guitar 100. Bridge pickup 118 is disposed next to bridge 104. Perspective view FIG. 1B and side plan view FIG. 1C show construction details of driver 110. Driver 110 comprises coils 111 and 113 wrapped around cores 112 and 114, respectively. Coils 111 and 113 are positioned side-by side in close proximity to each other. Permanent magnet 116 is magnetized as shown by the N, S markings in side plan view FIG. 1c. Since cores 112 and 114 are made of magnetically permeable steel, core tops 117 and 118 of cores 112 and 114 respectively exert a magnetic pull upon the steel instrument strings 101-106. Coils 111 and 113 are wound in opposite directions with generally equal turns of wire. The two coils are usually connected in parallel but can be connected in series. When current of one polarity flows through the two coils, the magnetic flux in the two cores adds to the permanent magnet flux that already exists there, and the magnetic forces upon the instrument strings increases. When current of the opposite polarity flows through the two coils, the magnetic flux in the two cores subtracts from the permanent magnet flux that already exists there, and the magnetic forces upon the instrument strings increases. By applying an alternating current from the sustainer amplifier to the two coils 111 and 113, the string vibrations are sustained.

A driver transducer comprising two identical coils with opposite winding directions, and polarized with opposite permanent magnet flux, radiates equal but oppositely-polarized magnetic fields vertically along axes 105 and 107 shown in FIG. 1c. As the vertical distance from the driver increases, the total flux tends to cancel out due to the two fields of equal but opposite polarity. The flux cancellation along vertical axes 105 and 107 tends to be quite complete. This results in very little residual flux as the distance from driver 110 increases. At the location of bridge pickup 118, the flux cancellation is not as perfect, however. This is because bridge pickup 118 is closer to driver pole 112 than to pole 114. This results in bridge pickup 118 producing an output signal in response to the radiated alternating magnetic field of driver 110, leading to a potential oscillatory condition.

By attaching additional magnetic plate 115, made of material that is similar to cores 112 and 114, the inductance of coil 111 is made greater than that of coil 113. The result of this is that coil 111 has greater inductance and there for conducts less current for parallel-connected coils (causing it to radiate less magnetic flux) than coil 113. This changes the location of best cancellation of the radiated magnetic fields. By unbalancing the radiated flux from coils 111 and 113 by a carefully chosen amount due to proper sizing and positioning of shunt plate 115, a more perfect cancellation of the two radiated fields occurs in the vicinity of bridge pickup 118. This more perfect cancellation of the two radiated fields allows the sustainer amplifier gain to be set to a substantially higher value before uncontrolled oscillation occurs than if the shunt plate 115 was not used. This is because bridge pickup 118 receives substantially less radiated flux from the driver 110 than before the unbalancing technique was added.

For series-connected coils, plate 115 would be moved to the other side of the driver, adjacent to coil 113, thereby raising its inductance. Since both coils conduct identical currents, the amount of radiated flux from coil 114 is greater than that from coil 112, creating a similar magnetic cancellation at the location of bridge pickup 118.

Driver 110 has a cosmetic appearance that is similar to that of many pickups that are sold in the marketplace. This is another property that makes it a desirable driver for a sustainer.

In our U.S. Pat. No. 5,050,759, the present inventors designed an embellishment to the '388 driver. This embellishment enabled the '388 driver to function as an instrument pickup when the sustainer was turned off. This embellishment was useful because a single electromagnetic transducer could function as both a driver and a pickup. An existing pickup could be replaced with this dual-purpose transducer, allowing both functions to be accomplished within the same instrument body pickup cutout, without any enlargement of the cutout being necessary. This is an important feature of a magnetic sustainer, because it allows the instrument to have flexible functionality without substantially changing the appearance of the instrument. This driver design was used on the Sustainiac GA-1 and Sustainiac GA-2 sustainers, which were sold during 1989-1991.

The '388 driver design was found to work quite well in sustainers having a humbucking bridge pickup as the sustainer pickup 118. However, it was found that if a single-coil bridge pickup was used with the '388 driver, excessive magnetic crosstalk existed between the driver and pickup. This is because the single-coil pickup has very poor inherent magnetic pickup immunity compared to a dual-coil humbucker pickup. Uncontrolled oscillation occurred at a gain setting that was too low to provide robust sustainer operation. Therefore, this type of driver transducer was confined mostly to being used on guitars wherein the sustainer pickup was a humbucking type. Furthermore, it was found that if sustainer pickup 114 was moved from the bridge pickup position to the position of middle pickup 119, magnetic cancellation was not adequate because of its close proximity to driver 110.

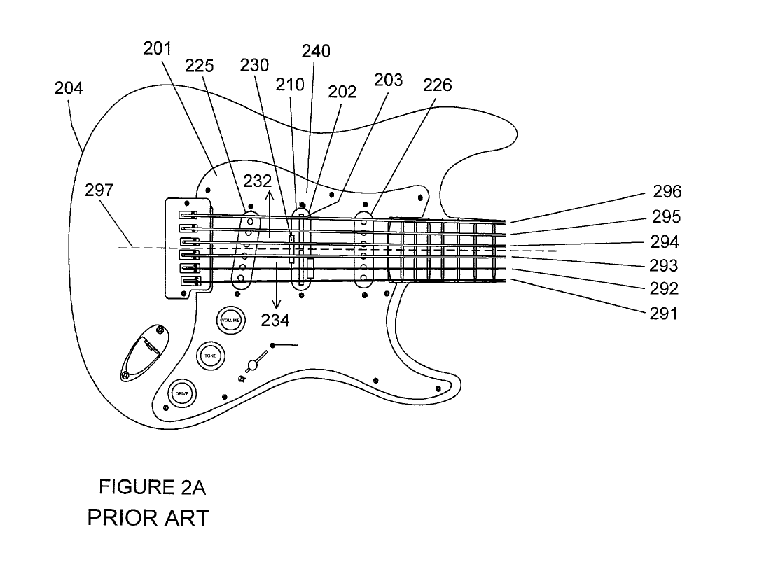

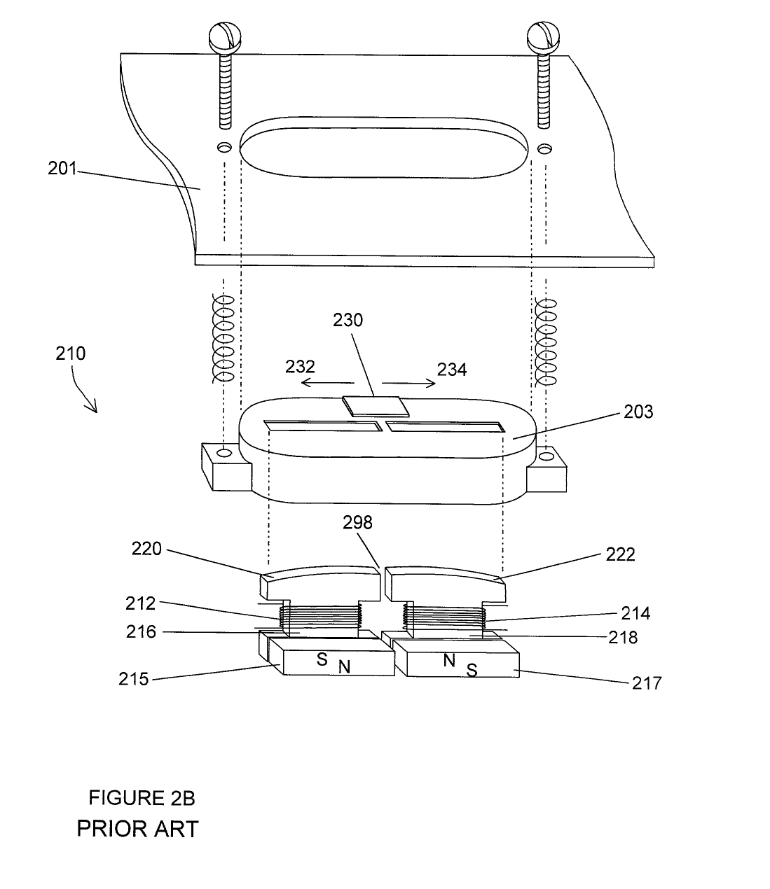

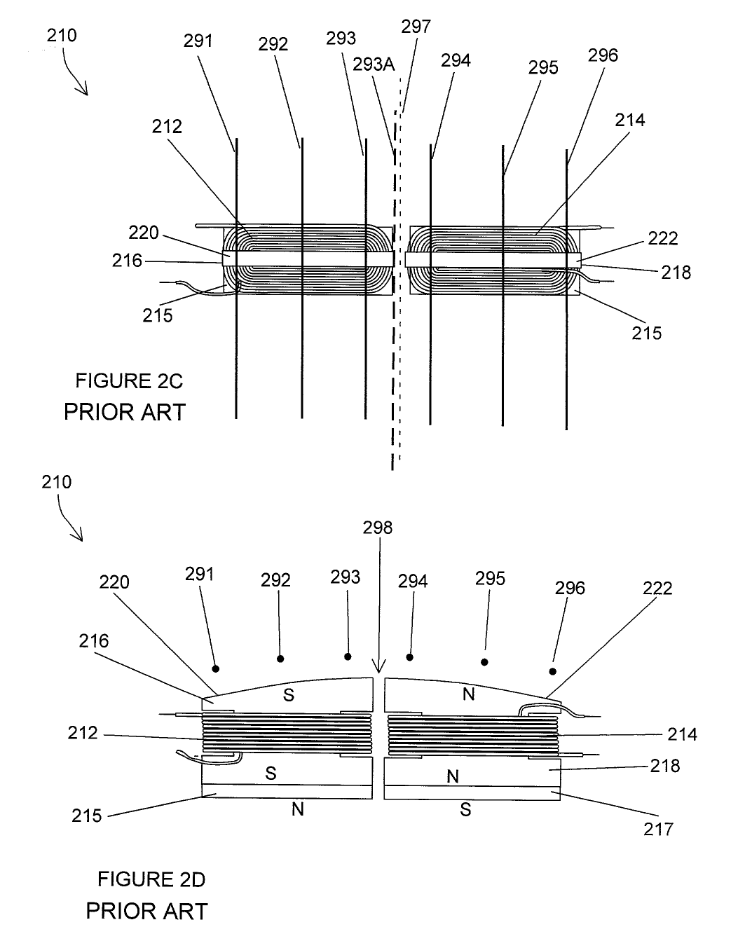

In our U.S. Pat. No. 5,932,827, the present inventors described an improved dual-coil magnetic driver that reduced magnetic crosstalk between driver and pickup to a level significantly less than that achieved in '388. FIG. 2 shows a driver as described in our '827 patent. This “bilateral” driver allowed a substantial increase in amplifier gain from the prior art to be set before magnetic crosstalk between driver and pickup caused uncontrolled oscillation of the sustainer. The “bilateral” term was defined in '827 to denote the generally side-by-side relationship between the two coils. Also, '827 particularly described the fact that one of the two coils drives the first three strings of a six-string guitar while the second of the two coils drives the second three strings of the instrument. The two coils are wound with opposing winding direction, while the coil permanent magnet polarities are opposite.

FIG. 2A shows a top plan view of bilateral driver 210 as it mounts into the single-coil pickup cavity 202 of a typical electric guitar body 204. Pickguard 201 attaches to body 204. Its purpose is to protect the body from scratches and also provides a convenient way to mount all of the pickups, driver, and electronics. It is not necessary to have a pickguard on the instrument. Strings 291-296 are shown passing over driver 210. Cover 203 protects the inner parts of the driver from damage.

FIG. 2B shows an exploded perspective view of driver 210. This depicts the mounting details of driver 210 to pickguard 201. It also depicts assembly details of driver 210, showing the spatial relationship between coils 212 and 214, respective cores 216 and 218, and respective permanent magnets 215 and 217 showing oppositely polarized magnets. In the '827 patent, core tops 220 and 222 are described as “flux emitters”.

FIG. 2C shows a detailed top plan view of driver 210 with no cover on it, depicting the relationship between coils 212 and 214, and respective cores 216 and 218. FIG. 2D is a front plan view showing the special shape of cores 216 and 218 near the respective flux emitters 220 and 222.

Coils 212 and 214 are wound upon cores 216 and 218, respectively. These cores are made of magnetically permeable steel. The coil wire is shown wound directly upon the cores. Alternatively, the wire could be wound upon bobbins that would then be placed over the cores. As with the '388 driver, the two coils of the '827 driver are wound in opposite directions over oppositely polarized magnetic cores.

The tops 220 and 222 of cores 216, 218 respectively are extended laterally in order to provide a larger magnetic radiating surface so that all of the strings 291-296 will be driven evenly with magnetic force. The extended core tops (flux emitters) extend beyond the core bodies but do not quite touch between strings 293 and 294. This narrows the magnetic gap between cores 216 and 218. This is explained in our '827 patent.

The side-by-side “bilateral” arrangement of the two coils 212 and 214 radiates approximately equal but oppositely polarized magnetic flux along a center locus 297 between the strings in the longitudinal direction of the instrument strings 291-296 toward bridge pickup 225 and neck pickup 226. This symmetrical flux distribution results in a substantially reduced amount of magnetic crosstalk between the driver and pickup than has previously been possible. Because of the symmetrical flux distribution along the longitudinal center locus of the strings, the instrument pickups receive an approximately equal amount of both north-seeking and south-seeking magnetic polarities from the driver. This produces very small amplitude induced pickup voltage due to the magnetic flux radiated from the driver. This results in a reduced tendency for an uncontrolled oscillatory condition to exist in the sustainer amplifier.

In gap 298 between the two polepieces, since the magnetic polarities of the two polepieces are opposite, the magnetic is concentrated straight across the gap rather than extending upward toward the strings where it is needed to interact with the steel instrument strings.

By providing a narrowed magnetic gap of the proper width, the strings can be bent further toward the center line 297 as shown in FIGS. 2a, and 2c, and still be in the flux fields radiated by the respective core polepieces than if the gap was wider. If the gap is too narrow, then the polepieces have magnetic “short circuit” near center line 297, and no flux is radiated toward the strings in that area. A gap of about 0.08-inch has been found experimentally to be the optimum gap width.

This is important, because “string bending” is common playing technique of many guitarists. Certain notes are often given accent by manually bending one or more strings being played, resulting in a note or combination of notes becoming progressively more sharp as the amount of string bending increases. A depiction of a typical bent string is shown in FIG. 2c by dashed line 293A. This represents the G-string 293 of electric guitar 204 being bent from its rest position to a new position near center locus 297. Use of a sustainer on an electric guitar provides additional enhancement to notes that are embellished by string bending after plucking the note or notes.

Obviously, if an instrument has an odd number of strings rather than even as has been described herein, then that string would likely lie along center line 297 without any string bending occuring.

A further improvement of the bilateral driver design described in the '827 patent was the addition of a magnetically permeable sliding plate 230 which is shown in FIGS. 2a and 2b. Plate 230 is positioned by sliding back and forth in directions 232 and 234 as shown. The magnetically permeable sliding plate allows the inductance of each of the driver coils to be changed by repositioning the plate. By placing the magnetically permeable plate closer to one coil than the other, the inductance of that respective coil is increased relative to the other coil. The coil with raised inductance radiates less flux than the other coil when both coils are connected in parallel, because the coil with raised inductance has higher impedance. This results in less current flowing in that coil than in the other coil for parallel-connected coils. (For series-connected coils, both coils have the same current. The coil with higher inductance will radiate more flux.)

By carefully moving this sliding plate while increasing the gain of the sustainer amplifier, a plate position can be determined whereby the total north-seeking flux polarity radiated by the driver that is sensed by the pickup is precisely balanced by the total south-seeking flux polarity. This results in a substantially reduced amount of magnetic crosstalk between the driver and pickup. The improvement in reduced crosstalk that the sliding plate contributes can be of the order of 20 dB or more over the driver of the '388 patent. The precise position whereby optimum flux cancellation is achieved is easy to determine simply by playing sustained notes, while listening to the pickup output signal through an ordinary electric guitar amplifier. This null position is easily determined empirically by listening to the instrument amplifier while moving the plate. The plate position that produces a minimum amount of distortion and noise characteristic of the instrument pickup signal is the optimum position.

The resulting benefit from such a bilateral driver design is that virtually any magnetic pickup can be used as the sustainer pickup, including single-coil type pickups. Furthermore, closer spacing between driver and pickup is allowable than before. The driver can be placed in the middle position 240 or alternatively, a middle pickup in position 240 can be used as the sustainer pickup with the driver being placed in either the bridge pickup or neck pickup positions. Also, as described in the '388 patent, the driver of the '827 patent can be used as a pickup when the sustainer is off by either amplifying or transforming the output voltage.

One significant problem exists with the driver design of the '827 patent, which is described in the following paragraph:

If a string being bent happens to move directly over gap 298 between polepieces 220 and 222 of FIG. 2c, as is common if the musician pushes with the fretting hand on the G-string 293 of a typical electric guitar, then the string vibration amplitude drops off rather abruptly by approximately 6 dB or even more. Conversely, if the sustainer is off and the driver is being used as a pickup, then the pickup output voltage amplitude decreases by a similar amount when a string is bent over the gap. This is an undesirable situation.

Since the two driver polepieces are of opposite magnetic polarity, and the gap dimension is rather small, preferably approximately 0.08 inch, the magnetic flux in between the two polepieces is largely confined to the gap. Very little of the flux reaches the strings where it is wanted. This is why the driver produces weak drive forces on the strings when they are bent into the region immediately above the gap, resulting in a reduction in sustained string vibration. It is also why the driver when used as a pickup produces very little induced voltage due to string vibration when a string is bent over the gap. By making the gap small, this area of flux reduction is minimized.

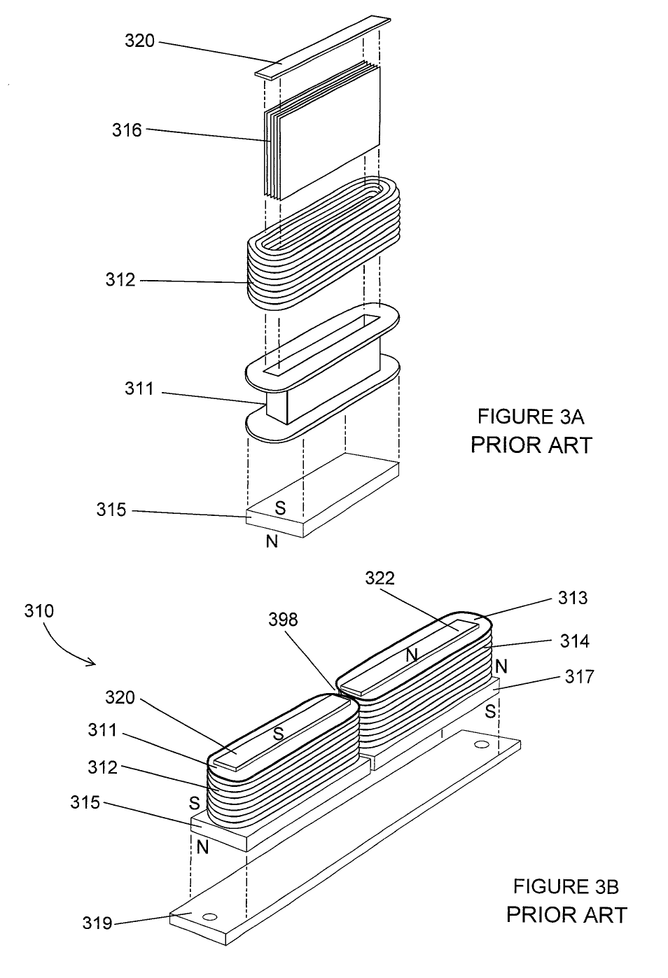

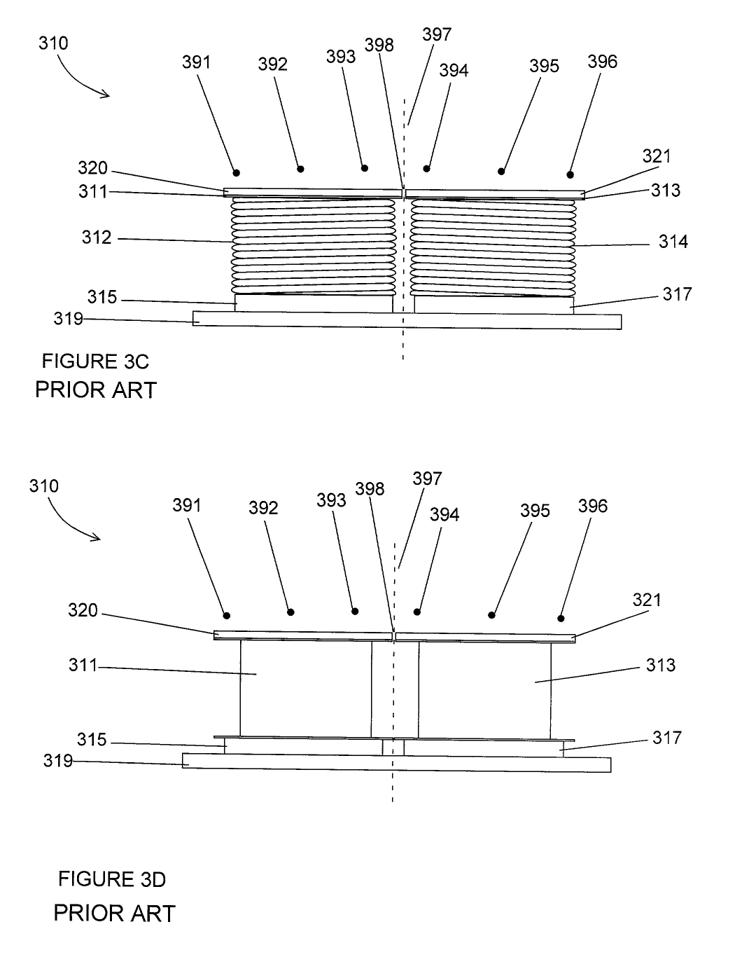

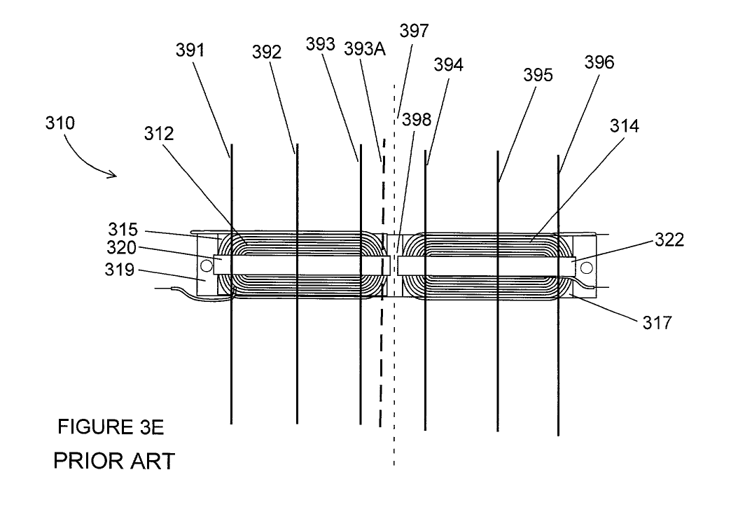

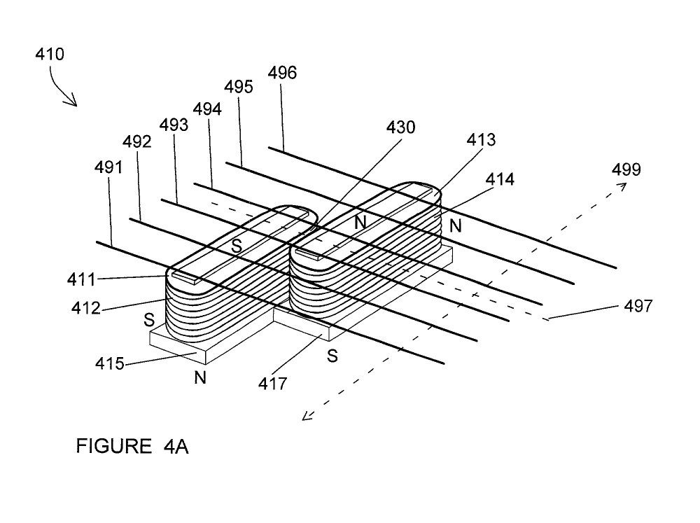

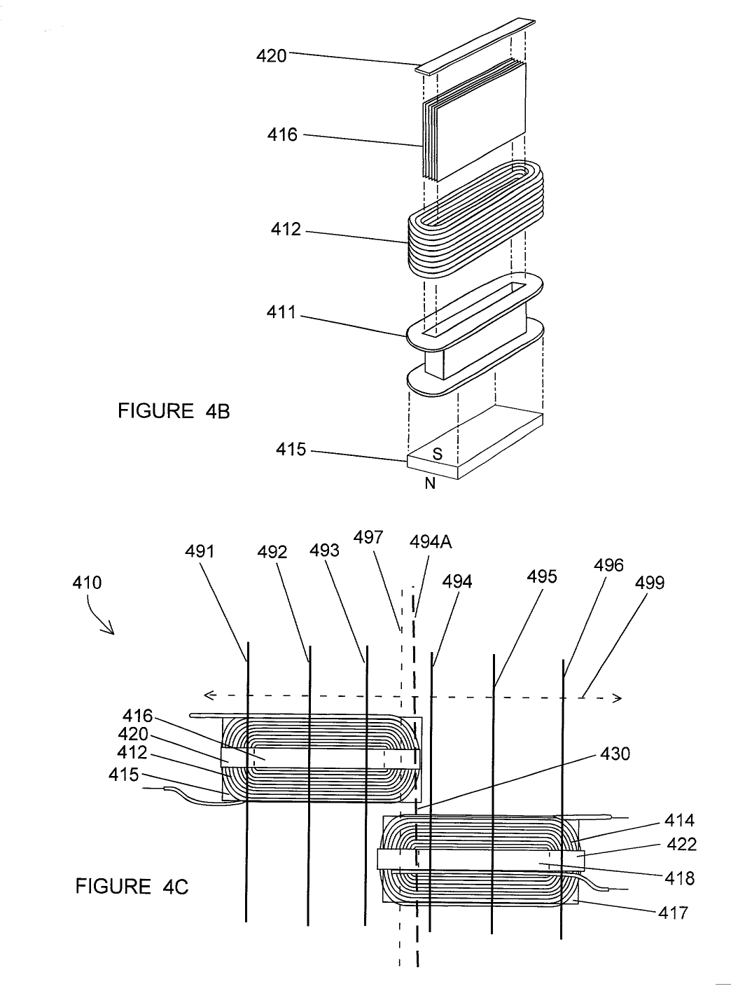

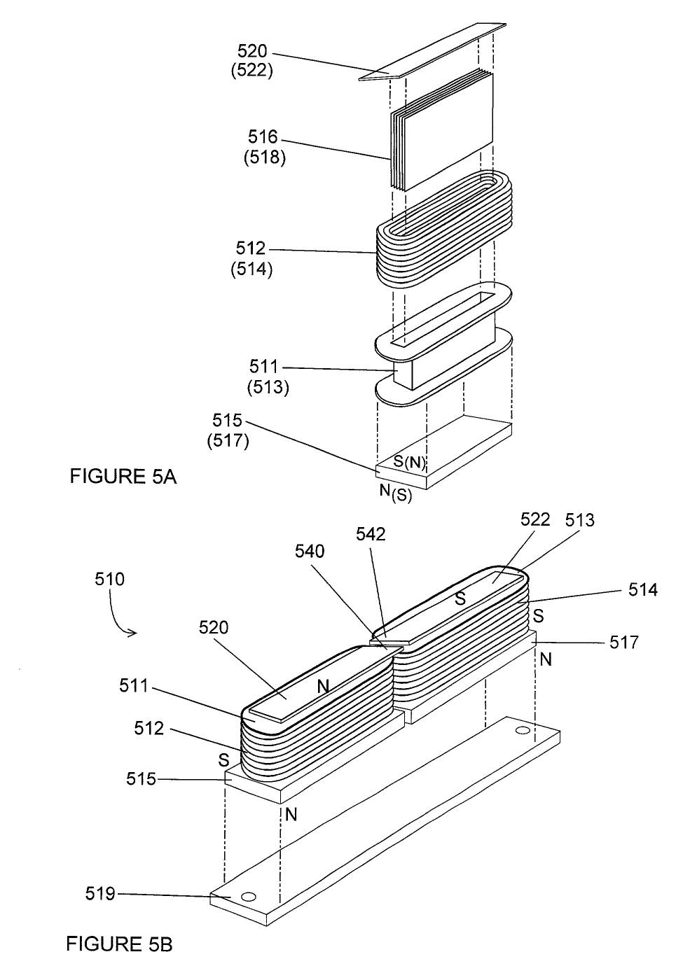

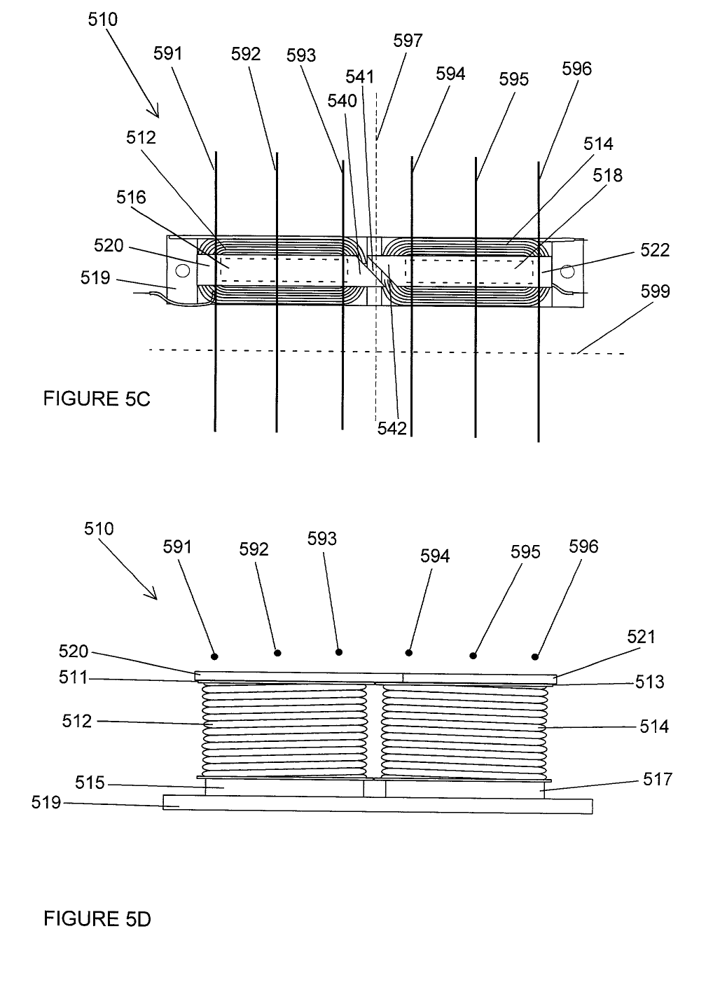

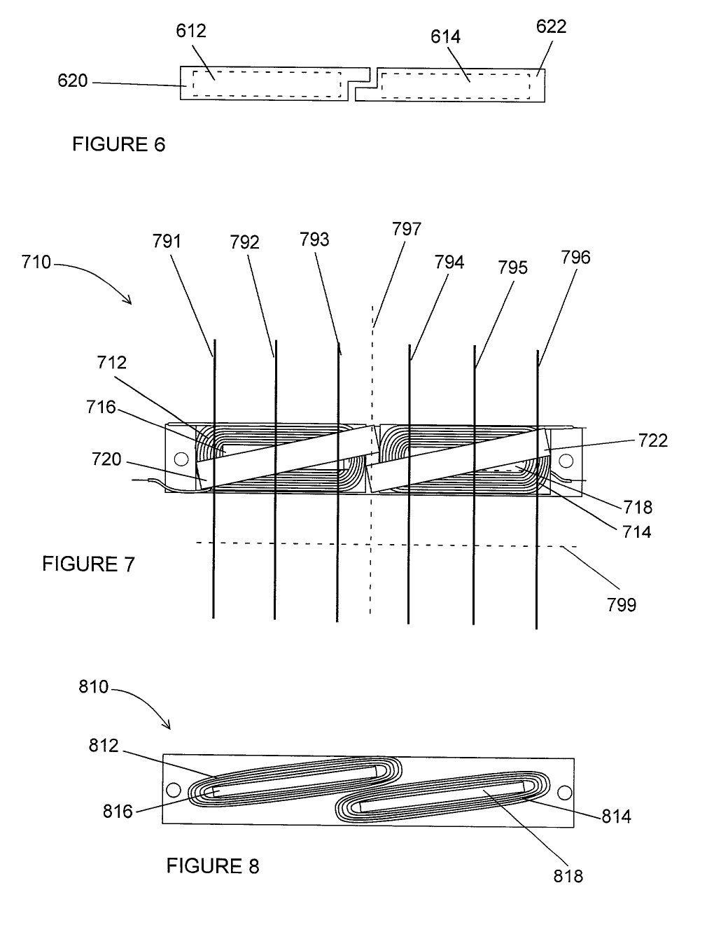

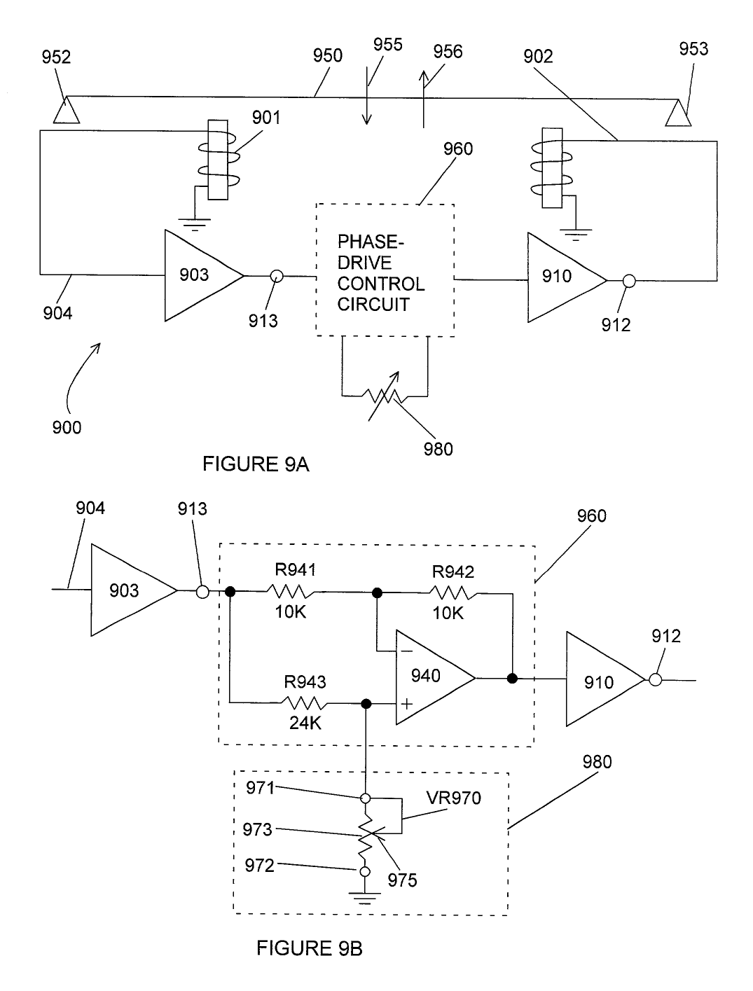

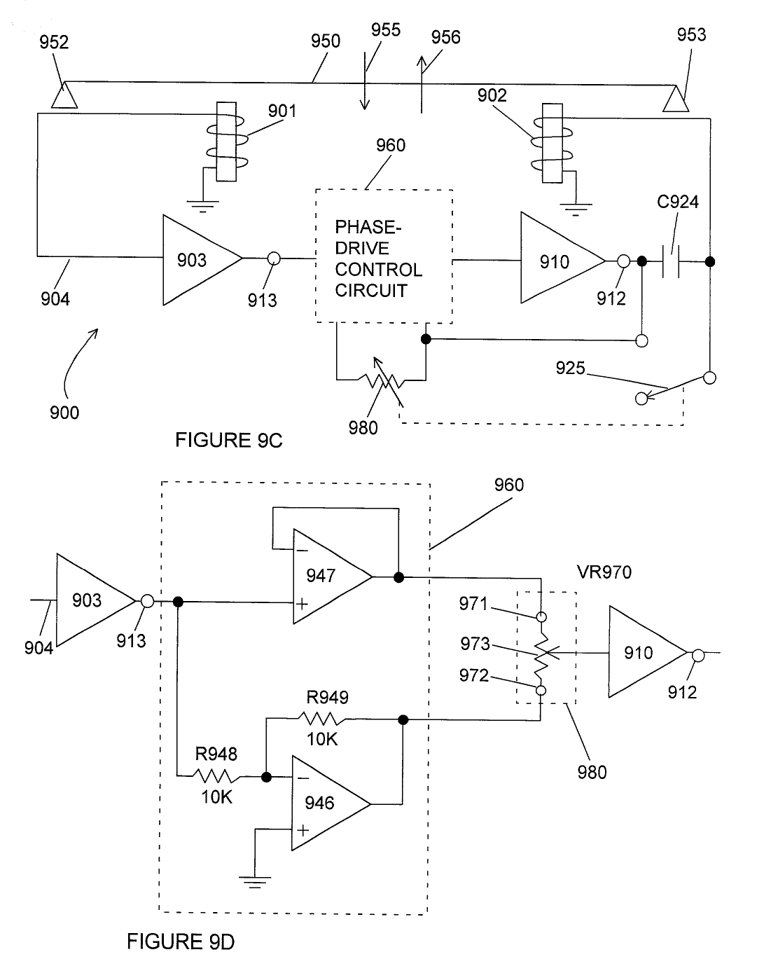

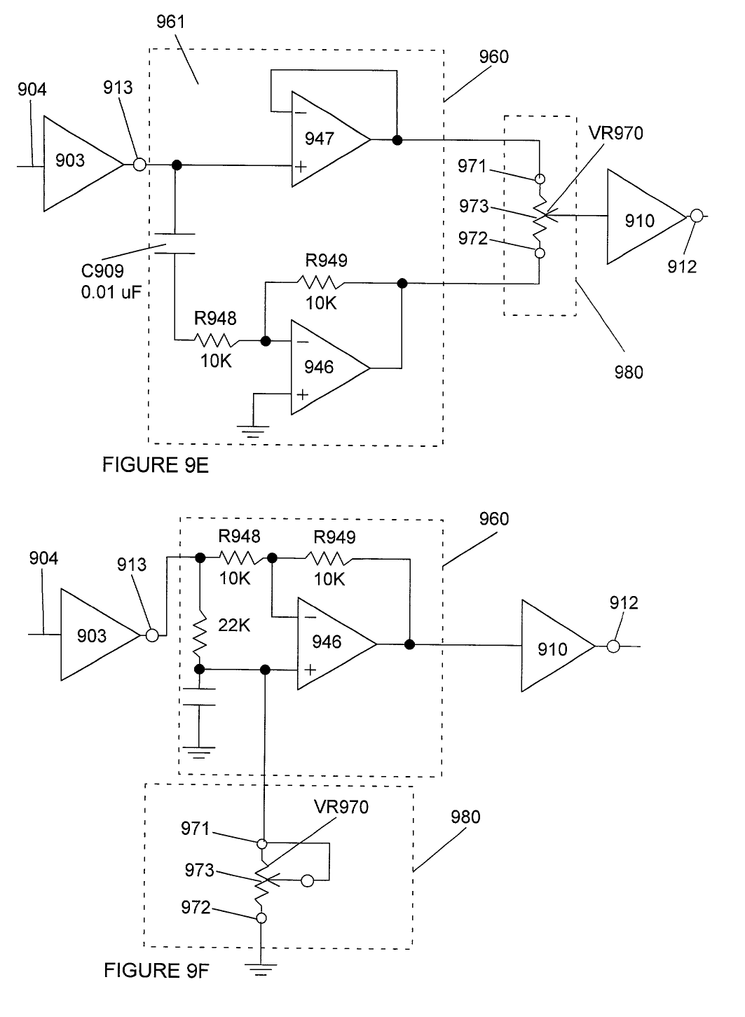

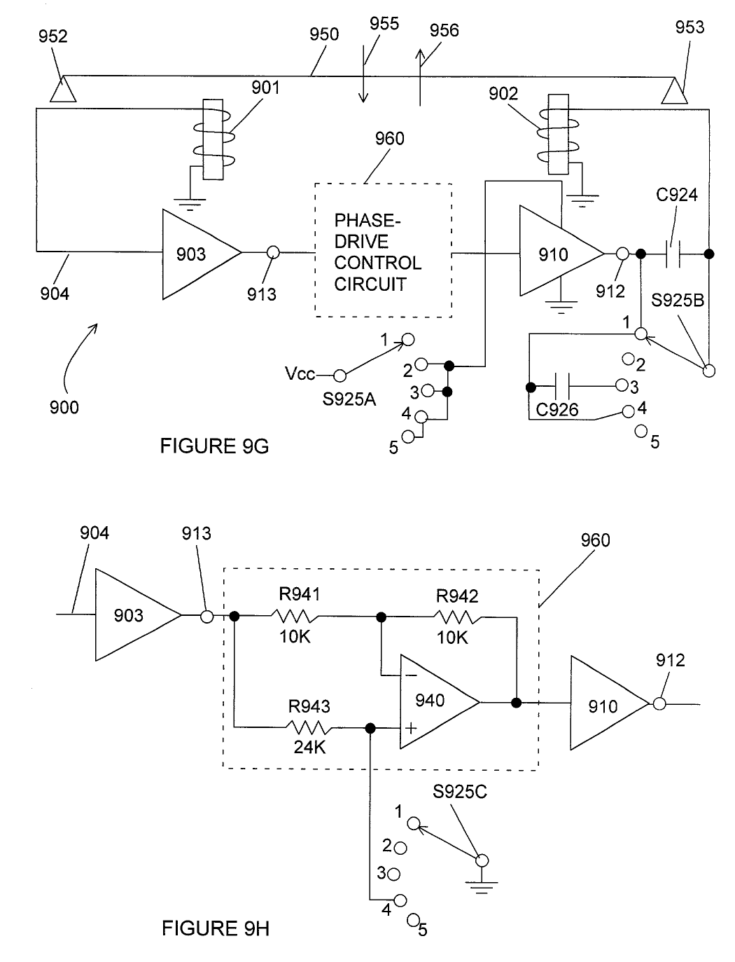

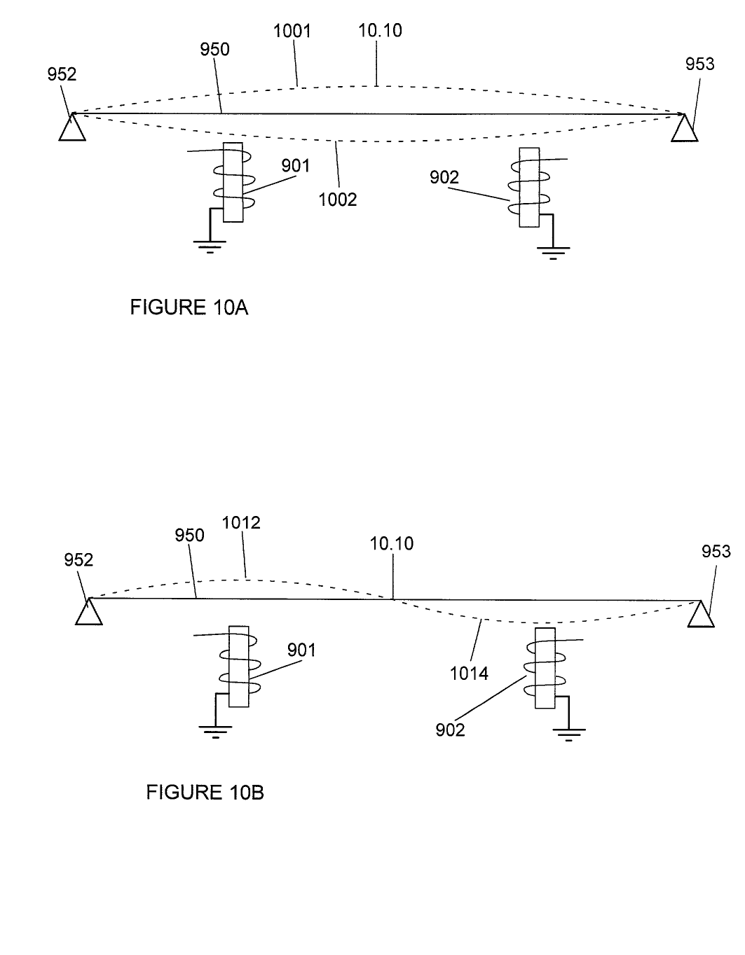

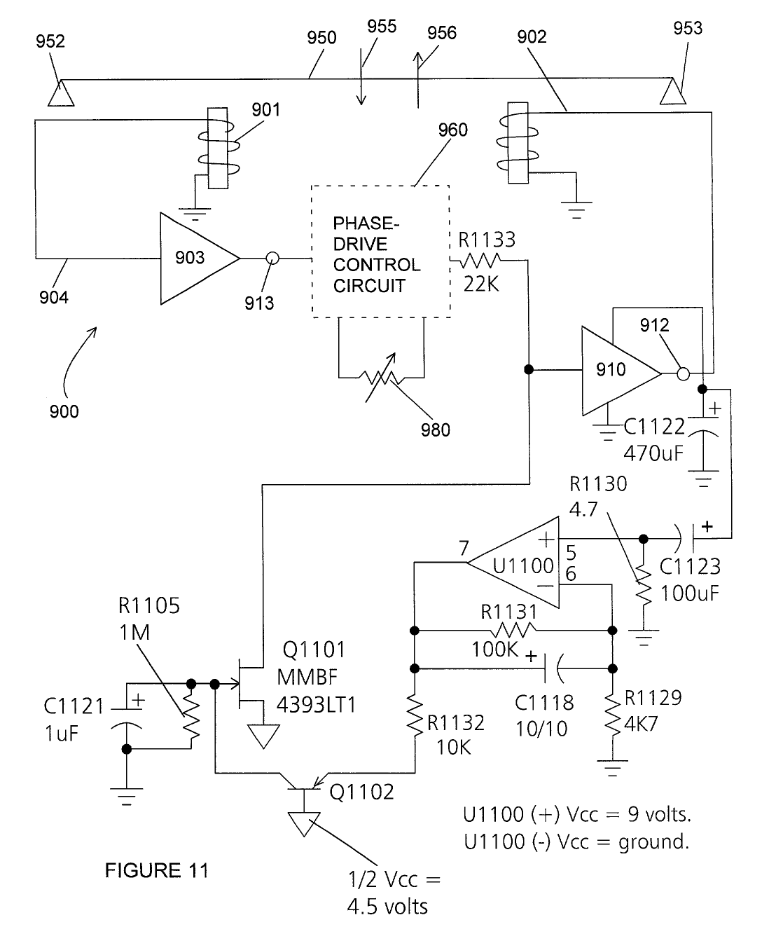

A new sustainer was placed on the market in July, 1999 when it was exhibited at the summer convention of the National Association of Music Merchants at Nashville, Tenn. This sustainer is utilizes a driver that possesses the characteristics of the '827 patent. This sustainer is called the Sustainiac Stealth sustainer. The bilateral driver used in this sustainer had features described in our U.S. Pat. No. 5,932,827. It's construction, shown in FIG. 3, is similar to the bilateral driver shown in FIG. 2 but with some differences.

FIG. 3 shows bilateral driver 310. The driver outer covering is not shown so that the driver details are more clearly depicted. FIG. 3A shows an exploded perspective view of one of the two similar coil assemblies. FIG. 3B shows a perspective view of the driver, with its relationship to mounting base 319 shown in exploded view. FIG. 3C shows a front plan view of the driver. FIG. 3D shows a front plan view of the driver as in FIG. 3C, except with the winding removed to better show the relationship of polepieces 320, 321 to cores 316, 318, respectively. FIG. 3D shows a top plan view of driver 310.

Coils 312 and 314 are wound upon bobbins 311 and 313 respectively, with oppositely directed windings. Bobbins 311 and 313 are placed over cores 316 and 318 respectively. Cores 316 and 318 are preferably composed of laminated sheets of magnetically permeable material such as transformer laminations. Cores 316 and 318 are inserted into respective bobbins 311, 313. Polepieces 320 and 322 are attached to the tops of cores 316 and 318, respectively. Polepieces 320 and 322 are extended beyond cores 316 and 318 to provide a small magnetic gap 398. Cores 316 and 318 and bobbins 311 and 313 are attached to metal baseplate 319 to provide a mounting bracket for driver 310.

A problem of this driver design is attenuation of sustained string vibration when a string is in the position of center line 398, directly above gap 398, or when a musician bends one of strings 391-396 into center position 397. FIG. 3D shows a detail of string 393 in a bent position 393A over gap 398. Furthermore, when using the driver as a pickup by amplifying the driver output voltage amplitude, attenuation of the output voltage occurs when bending the instrument strings into this center position 397 over gap 398. This attenuation of either sustained vibration amplitude or driver output signal is easily heard when bending a string into position 393A, and is therefore an undesirable characteristic of the present state of the art of bilateral drivers.

Alternatively, an instrument with an odd number of strings (1, 3 5, 7, etc.) would have one string (not shown) disposed in the position of longitudinal center axis 397. Therefore, this center string has the same attenuation problem of the above paragraph.

The problem is caused because strings that are located near center position 397 above gap 398 are impinged upon by a magnetic field which is less in intensity than that of strings located in the other positions shown in FIG. 3. The reason the magnetic flux is reduced near gap 398 is because the magnetic field that is emitted by polepieces 320 and 322 is mostly concentrated across the gap, and not above the gap. Therefore it doesn't reach the strings.

One aspect of the present sustainer invention is to solve this problem of reduced magnetic field above the gap between the polepieces of a bilateral driver, and the resulting attenuation of sustained string vibrations when bending strings of an electric guitar or other stringed instrument over this gap or when an instrument has an odd number of strings (1, 3, 5, 7, etc), and one string is located above this gap. Another aspect of the present sustainer invention is to solve the resulting problem of reduced pickup output voltage amplitude when the driver is used as a pickup when a string is located over this gap.

Controls for Magnetic Sustainers

Another aspect of magnetic sustainer design that could benefit from improvement is the means of controlling certain aspects of sustainer performance. Three sustainer parameters are typically controlled in modem sustainers by controls that are mounted to the instrument:

(1) On/off control: This typically comprises a switch for turning the sustainer on and off. It also simultaneously changes the instrument pickup from that which is selected by the instrument pickup selector switch to the one most suited to providing the input signal to the sustainer, regardless of which pickup is selected by the instrument pickup selector switch. This pickup-switching feature is necessary so that sustainer gain can be set to a high level. Such a control switch was contained in the Sustainiac GA-2 sustainer. This control is also one of the subjects of U.S. patent application Ser. No. 09/258,251 to Hoover et al.

(2) Drive control: This typically comprises a potentiometer for controlling the sustained string vibration amplitude. The corresponding electrical parameter that is controlled is the amplitude of the drive signal that is applied to the driver. Such a control was described in the '827 patent, and also in U.S. patent application Ser. No. 09/258,251. It is also found in several sustainers that are available in the marketplace, including the Sustainiac GA-2 sustainer.

(3) Harmonic control: This typically comprises a switch for reversing the phase of the drive signal. Such a control switch exists in the Sustainiac GA-2 sustainer. A similar control is also one of the subjects of U.S. patent application Ser. No. 09/258,251. When the drive signal is applied to the driver in such a manner as to produce a pulsating magnetic field that impinges upon the strings in phase with the string vibration, then the string is forced to vibrate in the fundamental mode. This is because the magnetic drive forces reinforce the string vibration by adding a small amount of energy during each single string vibration. By reversing the phase of the drive signal, the string is forced to vibrate in a harmonic mode of vibration that is different from the fundamental mode. Phase reversal of the drive signal causes the magnetic energy radiated by the driver to reach the strings out of phase with the fundamental mode of string vibration. This tends to remove vibrational energy from the string and thereby stop the fundamental vibration mode of the string. However, instead of causing all vibration to stop, one of the harmonic modes of vibration will usually occur. This is because in harmonic modes of vibration, one or more segments of a string are vibrating out of phase with one or more other segments of the string. Therefore, reversing the phase of the driver signal often forces an in-phase drive signal of one segment of a string vibrating in one of its natural harmonic modes, while the pickup is sensing another segment of the string which is out of phase with the segment being forced by the driver. Stated more simply, the harmonic mode of vibration occurs because the pickup is located in a region of the string in which the vibration has one phase, and the driver is located in a region of the string in which the vibration has the opposite phase. Since the drive signal is inverted, this tends to reinforce some harmonic mode of vibration of the string for most or all fret positions on a typical instrument. The closer the pickup and driver are spaced, the higher the harmonic vibration mode will usually be.

The Sustainiac GA-2 sustainer accomplished the on/off and harmonic control functions with two toggle switches 140 and 150, respectively. FIG. 1D shows how the on/off function of the Sustainiac GA-2 sustainer works. A three-pole, double-throw toggle switch 140 provides the combination on/off and automatic pickup selector function.

Buffer amplifier 130 buffers output signal 123 from bridge pickup 118. The buffered bridge pickup signal 131 is applied to operational amplifier 132 through input resistors 134, 136. Amplifier 132 amplifies the buffered bridge pickup signal. Drive potentiometer 180 controls the amplitude of the output signal of amplifier 132. Resistor 144 connects the wiper of drive potentiometer 180 to the input 133 of power amplifier 137. When sustainer power switch 140 is in the off position 146, pole 141C grounds the input 133 to power amplifier 137, preventing the input signal from reaching it. When switch 140 is in the on position 148, signal is allowed to pass on to the input 133 of amplifier 137.

Pole 141B connects the node 124 of driver transducer 110 to tap 127 of autotransformer 126 in the off position 146. Because driver 110 is used as a pickup when the sustainer is turned off, node 124 becomes a pickup output. Transformer 126 provides a step-up voltage at node 128 of the output signal voltage at node 124 of driver 110. When the sustainer is turned on by placing switch 140 in position 148, node 124 is converted from the output to the input of driver 110, and is connected to output 138 of sustainer driver amplifier 137 through pole 141B of on/off switch 140.

Pickup selector switch 160 selects either stepped-up output 128 of driver transducer 110, middle pickup 119, or buffered signal 131 of bridge pickup 118 when power switch 140 is in the off position 146. Pole 141A selects buffered bridge pickup signal 131 when the sustainer is on, regardless of which pickup is selected by instrument pickup selector switch 160. Resistor 137 provides a mixing resistance of appropriate value so that buffered bridge pickup signal 131 can be mixed with signals from middle pickup 119 and stepped-up neck pickup (driver) signal at node 128.

The installation manual for the GA-2 shows in detail numerous other sustainer connection schemes for popular electric guitars.

FIG. 1d shows how the harmonic control switch 150 of the Sustainiac GA-2 magnetic sustainer works. Resistors R134, R135, and R136 are equal in value. Toggle switch 150 has three positions 156, 157, and 158. Position 156 is “Fundamental” position. Opamp 132 functions as a unity gain “follower”. The signal reaches the input of power amplifier 137 in phase. Terminal 123 of driver 110 is connected to ground through switch 150. This causes the strings to vibrate in the fundamental mode of vibration, as explained above.

Position 158 is “Harmonic” position. Switch 150 provides a phase reversal of the drive signal by grounding the noninverting input (+) of amplifier 132 in this position, causing the strings to vibrate in the harmonic mode of vibration, as explained above.

Position 157 is “Mix” position. In this position, amplifier 132 functions as a unity gain “follower”, and the driver signal passes through the parallel combination of capacitor 152 and resistor 154, which causes a damped resonant response of the current through driver 110, because driver 110 has an impedance characteristic which is inductive. The resonant frequency is chosen to be approximately 1 KHz. This choice of resonant frequencies causes most notes played on the larger three strings of a typical electric guitar to sustain as harmonics. Most notes played on the smaller three strings of a typical electric guitar sustain as fundamentals. This “Mix” mode has proved to be popular with many musicians who own the Sustainiac GA-1 and GA-2 sustainers and later copies of these sustainers.

One problem with the above-described toggle switch sustainer controls is that they are installed onto an instrument by drilling holes in the body of the instrument. This causes permanent damage to the body, and therefore decreases the value of many instruments. U.S. Pat. No. 5,070,759 to Hoover described sustainer controls for both on/off and harmonic switching that are implemented utilizing push-pull switches that are an integral part of rotary potentiometers. These combination switch-potentiometers are readily available in the marketplace. With these controls, it is not necessary to drill any holes in the body of a typical electric guitar in order to install the sustainer. The combination switch-potentiometers simply replace existing control potentiometers of typical electric guitars. A shortcoming with this patent application however is that no harmonic “Mix” mode is described. A push-pull switch such as described can be configured to provide any two of the above-described modes: Fundamental, Harmonic, or Mix mode. However, because the push-pull switch has only two operating positions, only two of the modes can be actuated.

Another aspect of this sustainer invention is to provide a single combination switchpotentiometer control that overcomes this shortcoming.

AGC Circuits for Musical Instrument Sustainers

Automatic gain control (AGC) circuits have been described for sustainers. These circuits are used to provide high gain when the instrument vibrating element (or string) vibration is small, in order to provide robust sustain of played notes. Once the vibration reaches sufficient amplitude to be heard adequately, the sustainer amplifier gain should be reduced. Otherwise, amplifier clipping can occur, leading to distortion in the sustainer output signal, which can then be magnetically coupled to the instrument pickup from the driver. The result is a distorted sound, which is undesirable.

The AGC signal is used to automatically throttle back the system gain when a predetermined signal amplitude is reached.

Previous AGC circuits used in sustainers sense the instrument pickup signal in order to determine the vibrational amplitude of the vibrating elements of the instrument. The inventors believe that substantial improvement can be made to existing AGC circuits for sustainers.

### OBJECTS AND ADVANTAGES

Accordingly, several objects and advantages of our sustaining device are:

(a) To provide a bilateral driver for a musical instrument magnetic sustainer whereby uniform drive forces are applied to the strings if the instrument, even when the strings are located directly over or are bent into the area directly the magnetic gap between the two driver polepieces;

(b) To provide a bilateral driver for a musical instrument magnetic sustainer which can be used as a pickup when the sustainer is turned off, whereby uniform pickup response of all the instrument strings occurs, even when the strings located directly over or are bent into the area directly the magnetic gap between the two driver polepieces;

(c) To provide a single combination control for a musical instrument magnetic sustainer which provides the following control functions: (1) drive amplitude potentiometer; (2) harmonic/fundamental mode control, which changes the sustainer between two or three modes of operation, causing two or three modes of string vibration: Fundamental, harmonic, and a resonant mode which causes a mix between fundamental and harmonic string vibration;

(d) To provide a single combination control for a musical instrument magnetic sustainer which provides the following control functions: (1) Power on/off switching to sustainer amplifier; (2) harmonic/fundamental mode control, which changes the sustainer between three or four modes of operation, causing three or four modes of string vibration: Fundamental, harmonic, and two resonant modes which causes a mix between fundamental and harmonic string vibration;

(e) to provide a more uniform sustained vibration amplitude response for all of the strings on a typical electric guitar.

These objects and advantages of the invention will become apparent from a consideration of the drawings and ensuing description.

1. A sustainer for a musical instrument having at least one vibratory element arranged in a longitudinal direction, said sustainer comprising:
(a) means for providing a drive signal;
(b) driver means having a plurality of flux emitter means disposed in an end-to-end relation perpendicular to said longitudinal direction, defined as the lateral direction, for emitting a magnetic field to apply drive forces to said vibratory element in response to said drive signal;
(c) wherein at least two of said flux emitter means are magnetized by oppositely polarized permanent magnets;
(d) a gap narrowing means for narrowing a magnetic gap between at least two of said flux emitter means having oppositely polarized permanent magnets;
wherein said flux emitter means are arranged such that said gap narrowing means overlap each other in said lateral direction in order to improve magnetic drive of said vibratory element when said vibratory element is located near said magnetic gap.

2. The sustainer of claim 1 wherein said gap narrowing means comprises at least one of said flux emitter means having a portion overhanging a coil means in the direction of said gap to narrow said gap.

3. The sustainer of claim 1 wherein said driver is arranged to function as a pickup when the sustainer is turned off.

4. The sustainer of claim 2 wherein said driver is arranged to function as a pickup when the sustainer is turned off.

5. A sustaining device as set forth in claim 1 wherein:
(a) two of said flux-emitters have corresponding elongated quadrilateral-shaped pole pieces, each having a short side arranged so as to provide a projection,
(b) wherein each said flux-emitter has a corresponding magnetic core of opposite magnetic polarity,
(c) wherein said projections of said flux emitters provide gap narrowing means, and
(d) wherein said projections of said flux emitters overlap in said lateral direction, in order to provide more uniform drive force when said vibrating elements are near said gap.

6. A sustainer for sustaining the vibration of a vibratory element of a musical instrument comprising pickup means for providing a sustainer input signal in response to said vibration, said sustaining device comprising:
a. amplifying means responsive to said pickup signal for providing a drive signal in response to said pickup signal,
b. driver means responsive to said drive signal for applying a drive force to said vibratory element in response to said drive signal, wherein
c. said amplifying means includes a phase-drive control circuit means, comprising a single user-adjustable control, for causing said drive force to operate with continuously variable amplitude and also variable phase relative to vibration of said vibratory element, in order to
i) change vibration of said vibratory element between fundamental vibration and harmonic vibration and
ii) change vibration amplitude of said vibratory element.

7. A sustaining device as set forth in claim 6 wherein:
(a) said user-adjustable control includes a rotary potentiometer which is changeable between a predetermined first rotation position, a predetermined second rotation position, and a predetermined third rotation position, wherein said predetermined third rotation position is between said first rotation position and said second rotation position, and
(b) said phase-drive control circuit means includes a circuit means for
i) making said sustaining device sustain fundamental vibration of said vibratory element while said rotary potentiometer is changed to said first rotation position
ii) making said sustaining device sustain harmonic vibration of said vibratory element while said rotary potentiometer is changed to said second rotation position and
iii) iii) causing vibration of said vibratory element to cease while said rotary potentiometer is changed to said third rotation position.

8. A sustaining device as set forth in claim 6 wherein said user-adjustable control includes a switch means coupled to a capacitor for changing said drive signal.

9. A sustaining device as set forth in claim 6 wherein said phase-drive control circuit means includes an inverter means coupled to said user-adjustable control for changing the phase of said drive signal between inverted and non-inverted to change vibration of said vibratory element between harmonic vibration and fundamental vibration.

10. A sustaining device as set forth in claim 6 wherein said phase-drive control circuit means includes a phase-changing circuit means coupled to said user-adjustable control for making the phase of said drive force continuously variable relative to vibration of said vibratory element.

11. A sustainer for sustaining the vibration of a vibratory element of a musical instrument comprising pickup means for providing a sustainer input signal in response to said vibration, said sustaining device comprising:
d. amplifying means responsive to said pickup signal for providing a drive signal in response to said pickup signal,
e. driver means responsive to said drive signal for applying a drive force to said vibratory element in response to said drive signal, wherein
f. said amplifying means includes a sustainer control means, wherein said sustainer is controlled by a single user-actuated switch means, wherein said user-actuated switch causes the following actions to be accomplished:
i. switch sustainer from off to a fundamental vibration mode in a first position of said switch means;
ii. switch sustainer from said fundamental vibration mode to a harmonic vibration mode in order to change vibration harmonic mode of said vibratory element in a second position of said switch means.

12. The sustainer of claim 11, wherein said user-actuated switch means switches sustainer operation from said harmonic vibration mode to another harmonic vibration mode.

13. The sustainer of claim 11, wherein said user-actuated switch means switches sustainer operation from said another harmonic vibration mode to a third harmonic vibration mode.

14. The sustainer of claim 11, wherein said user-actuated switch means is a 3-position lever-actuated switch means.

15. The sustainer of claim 14, wherein said user-actuated switch means is a 5-position lever-actuated switch means.

16. A sustainer for sustaining the vibration of one or more vibratory elements of a musical instrument having pickup means for providing a sustainer input signal in response to said vibration of said vibratory element, said sustaining device comprising:
(a) amplifying means responsive to said pickup signal for providing a drive signal in response to said pickup signal, wherein said amplifying means is powered by a power supply;
(b) driver means responsive to said drive signal for applying a drive force to said vibratory element in response to said drive signal;
(c) automatic gain control circuit, also known as an AGC circuit, wherein said AGC circuit comprises an active device having a controllable resistance, wherein a control signal for controlling said controllable resistance is obtained from the power supply ripple voltage of said amplifying means.

17. The AGC circuit of claim 12, wherein the power supply ripple voltage of said driver amplifier is amplified and integrated in order to form a dc voltage which is proportional to said power supply ripple voltage, and wherein said dc voltage is applied to a voltage-controlled element, and wherein said voltage-controlled element resistance is used to modulate the gain of said driver amplifier in order to provide constant drive for multiple vibration elements of different vibration frequency.

18. The AGC circuit of claim 14 wherein said gain-controlled element is a field effect transistor.
